(19) United States
(12) Patent Application Publication
(10) Pub. No.: US 2007/0026153 A1
(43) Pub. Date: Feb. 1, 2007

(54) Anti-oxidation protection for parts made of carbon-containing composite material

(76) Inventors: Nathalie Nicolaus, Lyon (FR); Veronique Fontarnou, Meyzieu (FR); Nadia Roussarie, Corbas (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/280,588

(22) Filed: Nov. 15, 2005

(30) Foreign Application Priority Data
Aug. 1, 2005 (FR) 05 08196

(51) Int. Cl. B05D 3/02; B05D 1/18

(52) U.S. Cl. 427/372.2; 427/430.1; 427/180

(57) ABSTRACT

The method comprises the steps of: impregnating the part with a liquid impregnation composition containing at least a phosphate type compound, at least via a fraction of the outside surface of the part; applying a coating composition on said fraction of the outside surface of the part, the coating composition comprising a colloidal suspension of at least one refractory oxide in water, at least one compound essentially of the borosilicate type in powder form and having healing properties, and at least one metallic boride in powder form; and applying heat treatment after applying the coating composition.

### BACKGROUND OF THE INVENTION

The invention relates to providing protection against oxidation for parts made of a carbon-containing composite material, i.e. parts made of a material comprising fiber reinforcement densified by a matrix and in which at least the fiber reinforcement, or the matrix, or indeed an interphase between the reinforcing fibers and the matrix is made of carbon. A particular field of application for the invention lies in protecting parts made of carbon/carbon (C/C) composite material against oxidation, and in particular brake disks for aircraft.

In an oxidizing medium, the capacity of such parts to retain good mechanical properties at high temperatures depends on providing effective protection against the carbon being oxidized. After it has been made, the composite material inevitably presents residual internal pores, which pores provide the surrounding medium with access to the core of the material.

A well-known process for protecting carbon parts against oxidation consists in forming an outer coating of ceramic, in particular of silicon carbide SiC. Nevertheless, such coatings are often fragile and liable to cracking, and they cannot perform the function of providing a protective barrier against the oxygen of the surrounding medium in the long term. U.S. Pat. No. 4,931,413 proposes forming an outer coating from a composition that is a precursor for a glass ceramic that is capable of constituting a leakproof coating. That composition is made of a mixture of titanium diboride powder TiB₂ and of colloidal silica, possibly together with additional SiC powder.

In certain applications, the protection against oxidation provided to parts made of carbon-containing composite material must also retain its effectiveness even in the presence of moisture and/or of carbon oxidation catalysts. This applies in particular for airplane brake disks which can be exposed to the moisture present in runways, and which can come into contact with oxidation catalysts present in the de-icing compositions used on airport runways.

To provide better protection against catalytic oxidation of carbon, it is known to use internal protection based on one or more metal phosphates put into place by impregnating composite material parts with a composition in the form of an aqueous solution. In-depth impregnation within the pores of the material can be made easier by the presence of a wetting agent (or surfactant) mixed in the impregnation composition, or applied beforehand. Reference can be made in particular to U.S. Pat. No. 5,853,821.

Such internal protection is effective up to a threshold temperature above which its active elements decompose. In order to extend the range of protection to higher temperatures, proposals have been made also to form an outer coating on the surfaces of the parts.

The outer coating can then be in the form of a ceramic layer, e.g. of SiC. Thus, patent document WO 97/42135 describes a method of providing C/C composite material parts with protection against oxidation, in which internal protection containing aluminum and zinc phosphates is combined with external protection of SiC obtained by applying colloidal silica, drying, and performing heat treatment at high temperature (1600° C. to 1800° C.) so as to form SiC by chemical reaction between the silica and the carbon of the composite material. Nevertheless, as mentioned above, an SiC coating has difficultly in providing long-lasting sealing against the surrounding medium.

U.S. Pat. No. 6,740,408 proposes forming an outer coating having self-healing properties, i.e. having the ability of passing to a viscous state at the utilization temperatures of the parts, thereby plugging any possible cracks so as to form an effective barrier against diffusion of oxygen from the surrounding medium. The coating is obtained from a coating composition comprising a mixture of a powder of a borosilicate type vitreous compound, TiB₂ powder, and a binder comprising a ceramic precursor resin in solution in a solvent, typically a polycarbosilane (PCS) resin in solution in xylene. After the coating composition has been applied, steps of drying (elimination of solvent) and of curing the resin are performed. The polymer that is obtained by curing the resin is transformed into a ceramic by heat treatment, either before the parts are used, or on first exposure of the parts to high treatment on being used.

That method provides a real improvement in protection against oxidation at high temperatures because of the self-healing properties of the outer coating, due to the presence of the borosilicate type vitreous compound, i.e. essentially comprising the oxides B₂O₃ and SiO₂. The TiB₂ constitutes an oxide reservoir for regenerating the B₂O₃ which tends to become volatile when the temperature reaches 400° C. to 500° C. The oxide TiO₂ is also generated likewise compensating for the loss of B₂O₃ and increasing the viscosity of the vitreous compound, while preserving its self-healing ability.

Nevertheless, the use of a PCS resin in solution in xylene presents drawbacks. Xylene is inflammable and toxic and evaporates very fast on drying, thereby posing environmental and safety problems. In addition, the PCS needs to be cured in a controlled manner that is difficult to perform insofar as it determines the quality of the final protection.

### OBJECT AND SUMMARY OF THE INVENTION

An object of the invention is to remedy the above-mentioned drawbacks, and for this purpose the invention provides a method of providing protection against oxidation for a part made of composite material containing carbon and presenting open internal pores, the method including the steps of:

impregnating the part with a liquid impregnation composition containing at least a phosphate type compound, at least via a fraction of the outside surface of the part;

applying heat-treatment to the impregnated part to form internal protection against oxidation of the type comprising phosphate anchored within the composite material;

applying a coating composition on said fraction of the outside surface of the part, the coating composition comprising a colloidal suspension of at least one refractory oxide in water, at least one compound essentially of the borosilicate type in powder form and having healing properties, and at least one metallic boride in powder form; and

applying heat treatment after applying the coating composition.

Thus, the method of the invention does not require solvent that is difficult to handle, nor does it require a resin to be cured. In addition, as shown below, the resulting coating adheres well to the composite material, and in association with the internal protection, confers exceptional resistance to oxidation on the composite material.

The or each phosphate type compound of the impregnation composition may be selected in particular from the phosphates of aluminum, zinc, manganese, magnesium, and calcium. For example it is possible to use aluminum metaphosphate.

The colloidal suspension may comprise at least one oxide selected from the oxides of silicon, titanium, vanadium, yttrium, and zirconium, in particular silica SiO₂.

One or more metallic borides in powder form selected from the borides of titanium, vanadium, zirconium, and hafnium may be used, in particular TiB₂.

The coating composition preferably comprises, by weight:

25% to 50% refractory oxide in colloidal suspension;

0% to 20% water;

5% to 20% of a powder of a vitreous compound essentially of the borosilicate type; and

30% to 60% of a metallic boride powder.

Preferably, a first heat treatment is performed after impregnation with the impregnation composition, and a second heat treatment is performed after application of the coating composition. Advantageously, the second heat treatment is performed under an oxidizing atmosphere at high temperature for a relatively short duration.

### BRIEF DESCRIPTION OF THE DRAWING

Other features and advantages of the method of the invention appear on reading the following description provided by way of non-limiting indication and made with reference to the accompanying drawing, in which:

FIG. 1 shows the successive steps in an implementation of a method of the invention; and

FIG. 2 is a fragmentary face view of a brake disk of C/C composite material.

### DETAILED DESCRIPTION OF EMBODIMENTS

The description below relates to protecting C/C composite material parts against oxidation, and more particularly but not exclusively to protecting brake disks.

More generally, the invention is applicable to providing anti-oxidation protection for any parts made of a composite material formed at least in part out of carbon, where the carbon may be present in the fibers, in the matrix, or in an interphase layer between the fibers and the matrix.

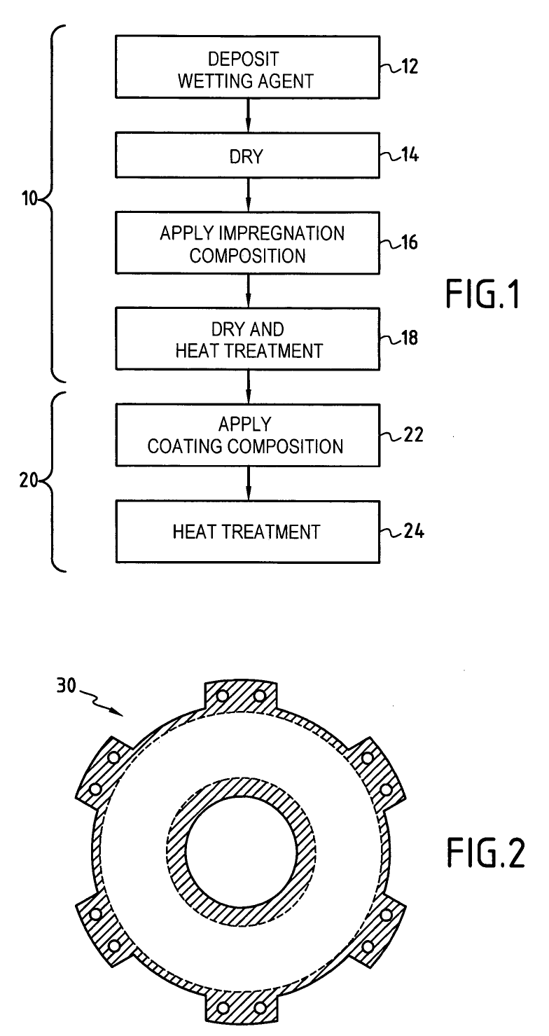

In the embodiment of the method represented by FIG. 1, a first stage 10 consists in impregnating a part or a portion of a part made of C/C composite material that is to be protected against oxidation with an impregnation composition that is suitable for forming internal protection and comprising at least one metallic phosphate, in particular for the purpose of providing protection against catalytic oxidation of the carbon.

Advantageously, the procedure is as described in U.S. Pat. No. 5,853,821. A first step 12 consists in depositing a wetting agent within the accessible pores of the composite material. For this purpose, an aqueous solution of a wetting agent is used, e.g. the product sold by the German supplier Hüls under the name “Marlophen NP9”. After impregnation with the aqueous solution of the wetting agent followed by drying (step 14), an impregnation composition in the form of an aqueous solution containing at least one metallic phosphate is applied to the outside surface of the part, or selectively to determined zones of said surface using a brush or a spray (step 16). For example, the solution used is an aqueous solution of aluminum dihydrogenphosphate Al(H₂PO₄)₃. The wetting agent present on the surfaces of the pores facilitates penetration of the impregnation composition. Drying followed by heat treatment up to about 700° C. in a non-oxidizing atmosphere are then performed (step 18), leading to the surfaces of the accessible pores being coated in a C/C composite material to provide internal protection against oxidation.

For a brake disk 30 made of C/C composite material, as shown in FIG. 2, the application of the impregnation composition can be restricted to the non-rubbing outer surfaces (shaded zone in the figure), while the annular friction surface or both annular friction surfaces on opposite sides of the disk are not impregnated in order to avoid spoiling their tribological properties.

A second stage 20 consists in forming an outer coating having self-healing properties.

For this purpose, a coating composition is used that comprises: at least one refractory oxide in colloidal suspension in water; a borosilicate type vitreous compound in powder form; and at least one metallic boride in powder form.

The colloidal aqueous suspension may comprise at least one oxide selected from the oxides of silicon, titanium, vanadium, yttrium, and zirconium, e.g. it may be a colloidal solution of silica. It is preferable to use a colloidal solution that is stabilized. The stabilizer may be ammonia NH₃, sodium oxide Na₂O, or chlorine. The first two stabilizers NH₃ and Na₂O impart a basic nature enabling good adhesion for the internal protection provided by the acidic phosphates, and they are therefore preferred. The particles in the colloidal solution are essentially of a size that is smaller than 200 nanometers (nm), preferably lying in the range 5 nm to 100 nm, and more preferably lying in the range 5 nm to 40 nm.

The borosilicate type vitreous compound comprises the oxides B₂O₃ and SiO₂. Other oxides may be present for adjusting the temperature at which the compound passes to the viscous state that makes self-healing possible. By way of example, use is made of “Pyrex®” glass powder from the US supplier Corning or as provided by the British supplier Barloword Scientific (previously Bibby Sterilin), which glass has substantially the following composition (percentages by weight):

| | |
|---|---|
| SiO₂: | 80.60% |
| B₂O₃: | 12.60% |
| Na₂O₃: | 4.2% |
| Al₂O₃: | 2.25% |
| Cl: | 0.1% |
| CaO: | 0.1% |
| MgO: | 0.05% |
| Fe₂O₃: | 0.05% |

Other glasses could be used such as the borosilicate glasses referenced 823-01 to -05 from the US supplier Ferro, or the glasses sold by the German supplier Schott AG under the name “Duran” (preferably under the reference “8330”), “Suprax”, or “Borofloat 40”.

The metallic boride in powder form is at least one selected from the borides of titanium, vanadium, zirconium, and hafnium. It is preferable to use TiB₂.

Typically, the composition of the coating comprises, by weight:

25% to 50%, and preferably 30% to 40%, refractory oxide in colloidal suspension;

0% to 20%, and preferably 3% to 10%, water;

5% to 20%, and preferably 10% to 15%, vitreous compound that is essentially of the borosilicate type; and

30% to 60%, and preferably 35% to 50%, of metallic boride.

The coating composition is applied (step 22) to the outside surface of the composite material part, in places where the impregnation composition has already been applied to form the internal protection. Application can be implemented by spraying on the composition or by means of a brush. The quantity of the coating composition that is applied lies in the range about 10 milligrams per square centimeter (mg/cm²) to 30 mg/cm² before drying, and preferably in the range 12 mg/cm² to 22 mg/cm².

After the coating composition has been applied, heat treatment is performed (step 24). Various different heat treatment temperatures can be implemented:

1) mere drying at a temperature lying in the range 80° C. to 100° C. for one or more hours (h), or while progressively raising the temperature up to 200° C. to 250° C.;

2) relatively short heat treatment in an oven under an oxidizing atmosphere (e.g. air) at a temperature of about 800° C. to 850° C. for a duration of a few minutes (min) to a few tens of minutes, preferably after drying as in 1) above; or 3) heat temperature in an oven under a non-oxidizing atmosphere (e.g. nitrogen) at about 700° C., as for the internal protection.

Heat treatment 2) is preferred since it immediately produces an outer protective layer having improved adhesion and hardness, and forming an effective protection barrier against the oxygen in the surrounding medium.

With mere drying (heat treatment 1)), it is the subsequent exposure of the part to high temperatures in operation that produces an effect that is equivalent (but delayed) to the effect of initial heat treatment at high temperature.

The composite material part as provided in this way both with internal protection and with external protection against oxidation is ready for use. While it is being used at high temperature in an oxidizing atmosphere, any loss of B₂O₃ by volatilization is compensated by the supply of B₂O₃ (and TiO₂) by oxidizing the TiB₂, thus enabling the self-healing properties to be maintained.

In a variant, it should be observed that it is possible to perform only a single heat treatment operation, with the coating composition being applied after the impregnation composition but without drying or heat-treating the impregnation composition.

### EXAMPLE 1

Samples of C/C composite material were made in the following manner:

fiber plies were formed by superposing three unidirectional sheets of carbon fibers making angles of ±60° relative to one another, with the sheets being bonded together by light needling;

the resulting fiber plies were superposed and the plies were bonded together by needling as they were being superposed so as to obtain a thickness of several centimeters;

circular preforms were cut out from the fiber plate as obtained in that way; and

the preforms were densified by a matrix of pyrolytic carbon formed by chemical vapor infiltration so as to obtain a relative density equal to about 1.73.

The resulting samples were impregnated with an aqueous solution containing 0.5% by weight of a wetting agent (surfactant) sold by the German supplier Hüls under the name “Marlophen 89”. For this purpose, the samples were immersed in a bath of said solution contained in a tank associated with an ultrasound generator for encouraging the solution to penetrate into the cores of the accessible pores in the composite material. The samples were subsequently dried at about 100° C. for 5 h leaving a film of wetting agent on the walls of the pores in the material.

Thereafter, an impregnation composition constituted by an aqueous solution having 50% by weight of aluminum dihydrogenphosphate Al (H₂PO₄)₃ was subsequently impregnated by applying the solution to the outside surfaces of the samples in a quantity corresponding to 20 mg/cm².

After heat treatment in air for several hours by progressively raising the temperature up to about 350° C., heat treatment was performed under nitrogen by raising the temperature to about 700° C. and maintaining said temperature for about 1 h, so as to obtain samples provided with internal protection against oxidation based on phosphate anchored in the accessible internal pores of the composite material.

The resulting samples provided with such internal protection were split into three groups:

a) a first group of samples A that were left untouched;

b) a second group of samples B made from samples A and further provided with an external protective coating formed using a method in accordance with that described in U.S. Pat. No. 6,740,408 and comprising:

applying a coating composition to the outside surfaces of the samples, the composition comprising approximately, by weight: 19% of silicon resin (sold by the German supplier Wacker-Chemie GmbH under the reference “Wacker H62C”), 19% xylene (solvent of the resin), 13% by weight of “Pyrex®” glass powder, and 49% by weight of TiB₂ powder sold by the US supplier Alfa Aesar, the quantity of the applied coating composition being about 17 mg/cm²; and

heat treatment at about 220° C. for about 2 h after raising the temperature slowly (at about 1.5° C./h) in order to cure the silicone resin; and

c) a third group of samples C constituted by samples A further provided with an external protective coating made using a method in accordance with the present invention and comprising:

applying an aqueous coating composition on the external surfaces of the samples C, the composition comprising, approximately, by weight: 38.2 parts by weight of a 30% solution of colloidal silica in water (colloidal solution sold by the German supplier Chemische Fabrik Budenheim under the name “FFB33K”); 12.8 parts by weight of “Pyrex®” finely divided glass powder (grain size essentially less than 50 micrometers (μm)); and 48.9 parts by weight of TiB₂ powder sold by the supplier Alfa Aesar, the quantity of applied coating composition being 17 mg/cm²; and

heat treatment at about 90° C. for about 2 h.

The samples A, B, and C were exposed to various oxidizing conditions using test protocols as defined in Table I below.

The table gives the relative weight losses that were measured (expressed in percentage relative to the weight of the sample at the beginning of the test). Some of the tests were performed with the samples being “polluted” with potassium acetate (KAc) in an aqueous solution at 50 grams per liter (g/L), where KAc is a catalyst for oxidizing carbon and is commonly in substances for de-icing airport runways.

TABLE I

| | Reference | | | B | C |
|---|---|---|---|---|---|
| Oxidation | oxidation | KAc | A | 20⁽¹⁾ mg/cm² | 20⁽¹⁾ mg/cm² |
| conditions | conditions | present | 20⁽¹⁾ mg/cm² | 17⁽²⁾ mg/cm² | 17⁽²⁾ mg/cm² |
| 5 cycles of 5 h | p-650 | No | 4.6 | 1.4 | −0.054 |
| at 650° C. | | | | | |
| 5 cycles of 30 min | p-850 | No | 3.4 | −0.2 | −0.154 |
| at 850° C. | | | | | |
| 5 h at 650° C. + 15 min | p-1200 | No | 5.6 | 0.19 | 0.12 |
| at | | | | | |
| 1200° C. + 2 | | | | | |
| cycles of 5 h | | | | | |
| at 650° C. | | | | | |
| 5 h at 650° C. + 10 min | p-1400 | No | 10.4 | 3.7 | 3.1 |
| at | | | | | |
| 1400° C. + 2 | | | | | |
| cycles of 5 h | | | | | |
| at 650° C. | | | | | |
| 5 h at 650° C. + KAc | p-650 KAc | Yes | 6.6 | 2.7 | 2.05 |
| pollution + 2 | | | | | |
| cycles of | | | | | |
| 5 h at 650° C. | | | | | |
| 5 h at 650° C. + 15 min | p-1200 KAc | Yes | 55.9 | 30.6 | 36.17 |
| at | | | | | |
| 1200° C. + KAc | | | | | |
| pollution + 2 | | | | | |
| cycles of 5 h | | | | | |
| at 650° C. | | | | | |

⁽¹⁾quantity of the aluminum phosphate-based composition applied prior to heat treatment.
⁽²⁾quantity of the glass-based coating composition applied prior to heat treatment.

Negative values (i.e. increases in weight) are due to partial oxidation of TiB₂ giving the species TiO₂ and B₂O₃, and they do not mask any loss in weight.

It can be seen that the results obtained with the samples C are considerably better than those obtained with the samples A, and in most cases better than the results obtained with the samples B, but without presenting the drawbacks involved with applying the external protection on those samples.

Two A and C samples were subjected to a process comprising:

a) aging at 650° C. in air for 30 h.

During the last 5 hours of the aging, the respective measured weight losses were 1.3% and 0% for the samples A and C.

The sample C was then subjected to steps b) and c) below:

b) a damaging process by immersion in water in an ultrasound vessel for about 15 minutes followed by cleaning using a metal brush; and

c) exposure to air at 650° C. for 5 h.

A relative weight loss of 0.43% was then measured after step c), showing additional improvement in comparison with the relative weight loss of 1.3% as measured on sample A after step a).

Two samples A and C were subjected to a process comprising:

a′) the p-1400 oxidation protocol.

During the last 5 hours of that protocol, the respective weight losses as measured were 5.2% and 1.6% for the samples A and C.

The sample C was then subjected to the following steps b) and c):

b) a damaging process by immersion in water in an ultrasound vessel for about 15 minutes followed by cleaning using a metal brush; and

c) exposure to air at 650° C. for 5 h.

A relative weight loss of 2.4% was measured after step c), again showing an improvement compared with a relative weight loss of 5.2% as measured on a sample A after step a′) on its own.

In spite of its severity, the damage applied to the samples C (step b)) leads to little loss in the effectiveness of the protection.

Those tests, simulating severe aging in a moist environment also show the very high resistance of the samples C when compared with the samples A, even though oxidizing TiB₂ gives B₂O₃ which is known to be soluble in water.

### EXAMPLE 2

A sample D of C/C composite material was provided with an external protective layer like the sample C of Example 1, but omitting the phosphate-based internal protection. Table II below shows the results obtained (relative weight losses) with the samples C and D under two oxidation conditions.

TABLE II

| | C | D |
|---|---|---|
| Oxidation | 20⁽¹⁾ mg/cm² | — |
| conditions | 17⁽²⁾ mg/cm² | 17⁽²⁾ mg/cm² |
| p-650 | −0.054 | 0.731 |
| p-650 KAc | 2.05 | 6.95 |

The results obtained show the very considerable improvement in the protection by associating internal protection and external protection as compared with external protection on its own.

### EXAMPLES 3, 4, AND 5

A sample E was obtained by providing a sample A of Example 1 with external protection obtained by:

applying an aqueous composition comprising 36.4 parts by weight of “FFB33K” colloidal silica at a concentration of 30%, 4.8 parts of water, 12.2 parts of “Pyrex” glass powder, and 48.6 parts of TiB₂ from the supplier Alfa Aesar; and

heat treatment at 90° C. in air for 2 h.

A sample F was obtained like sample E except that the heat treatment was performed under nitrogen at 700° C. for 1 h.

A sample G was obtained like sample E, except that the heat treatment was performed in air at 800° C. for 15 min.

Table III below shows the results obtained (relative weight losses) after performing an oxidation test on the samples E, F, and G.

TABLE III

| Oxidation | | | |
|---|---|---|---|
| conditions | E | F | G |
| p-650 | 0.264 | 1.4 | 0.256 |

Short heat treatment at 800° C. in air is industrially preferable.

### EXAMPLE 6

A sample H was prepared like a sample A in Example 1, but using an aqueous solution of aluminum phosphate at a concentration of 48% as supplied by the German supplier Chemische Fabrik Budenheim and without proceeding with heat treatment after impregnation with that solution. Thereafter an aqueous solution was applied comprising 38 parts by weight of “FFB33K” colloidal silica at a concentration of 30%, 12.9 parts by weight of “Pyrex” glass powder, and 49.1 parts by weight of TiB₂ from the supplier Alfa Aesar.

Heat treatment was subsequently performed at about 700° C. under nitrogen for about 1 h.

After oxidation in air at 650° C. for 30 h, a relative weight loss of 2.5% was measured on the sample.

This example shows that it is possible to perform the heat treatment for internal protection and for external protection on a single occasion, but that the performance in terms of ability to withstand oxidation is significantly degraded.

### EXAMPLES 7, 8, 9, 10, AND 11

An example I was obtained by providing a sample A of Example 1 with external protection obtained by:

applying an aqueous composition comprising 38.2 parts by weight of “FFB33K” colloidal silica at a concentration of about 30% and stabilized by sodium by the presence of 0.4% to 0.5% by weight of Na₂O, 12.8 parts of “Pyrex” glass powder, and 48.9 parts of TiB₂ from the supplier Alfa Aesar;

heat treatment at 90° C. in air for 2 h.

A sample J was prepared like the sample I, but using an “FFB30K” colloidal silica from Chemische Fabrik Budenheim stabilized by the presence of about 0.3% by weight of Na₂O.

A sample K was prepared like the sample I, but using an “FFB30K” colloidal silica from Chemische Fabrik Budenheim stabilized by the presence of about 0.17% by weight of Na₂O.

A sample L was prepared like the sample I, but using an aqueous composition comprising 38.2 parts by weight of colloidal silica at a concentration of about 40% as supplied under the reference “Ludox AS 40” from the US supplier Grace Division and stabilized with ammonia, 12.8 parts of “Pyrex” glass powder, and 48.9 parts of TiB₂ from the supplier Alfa Aesar.

A sample M was prepared like the sample L, but using an aqueous composition comprising 30.8 parts by weight of colloidal silica, 14.4 parts of “Pyrex” glass powder, and 54.8 parts of TiB₂.

Table IV shows the results obtained (relative weight losses) under various conditions of oxidation for the samples C and I to M.

TABLE IV

| Oxidation | | | | | | |
|---|---|---|---|---|---|---|
| conditions | C | I | J | K | L | M |
| p-650 | −0.054 | −0.067 | −0.111 | 0.059 | −0.033 | −0.024 |
| p-850 | −0.154 | −0.214 | | | −0.17 | |
| p-1200 | 0.12 | −0.11 | | | 0.46 | |
| p-1400 | 3.1 | 3.52 | | | 3.50 | |
| p-650 KAc | 2.05 | 1.34 | | | 1.75 | |
| p-1200 KAc | 36.17 | 35.02 | 36.11 | 29.93 | 37.7 | 25.5 |

All of the colloidal silicas that were tested gave similar results.

### EXAMPLE 12

Samples A′ and C′ were made like the samples A and C, but applying the anti-oxidation protection on only one of the main circular faces and on the peripheral outline, while the other main face remained free from protection.

Friction tests were carried out on the samples A′ and C′ to measure firstly the coefficient of friction and secondly the effectiveness under braking conditions simulating an emergency landing. No significant difference was observed between the results obtained on a sample A′ and those obtained on a sample C′.

In addition, the samples C′ were exposed at 30° C. to relative humidity of 95% for durations of 1 day to 10 days and then the free face was examined using a scanning electron microscope provided with an EDX probe. No chemical species coming from the anti-oxidation protection was observed, thus making it possible to conclude that there was total absence of any migration of such species to a friction surface of a brake disk protected against oxidation in accordance with the invention by applying internal protection and external protection to its non-friction surfaces.

1. A method of providing protection against oxidation for a part made of composite material containing carbon and presenting open internal pores, the method including the steps of:
impregnating the part with a liquid impregnation composition containing at least a phosphate type compound, at least via a fraction of the outside surface of the part;
applying a coating composition on said fraction of the outside surface of the part, the coating composition comprising a colloidal suspension of at least one refractory oxide in water, at least one compound essentially of the borosilicate type in powder form and having healing properties, and at least one metallic boride in powder form; and
applying heat treatment after applying the coating composition.

2. A method according to claim 1, wherein the colloidal suspension comprises at least one oxide selected from the oxides of silicon, titanium, vanadium, zirconium, and yttrium.

3. A method according to claim 1, wherein the colloidal suspension is an aqueous suspension of colloidal silica.

4. A method according to claim 1, wherein the powder of at least one metallic boride comprises a powder of at least one boride selected from the borides of titanium, vanadium, zirconium, and hafnium.

5. A method according to claim 1, wherein the powder of at least one metallic boride is a powder of titanium diboride (TiB₂).

6. A method according to claim 1, wherein the coating composition comprises:
25% to 50% refractory oxide in colloidal suspension;
0% to 20% water;
5% to 20% of a powder of a vitreous compound essentially of the borosilicate type; and
30% to 60% of a metallic boride powder.

7. A method according to claim 1, wherein a first heat treatment is performed after impregnation with the impregnation composition, and a second heat treatment is performed after application of the coating composition.

8. A method according to claim 7, wherein the second heat treatment is performed under an oxidizing atmosphere at high temperature for a relatively short duration.
